(19) United States
(12) Patent Application Publication
(10) Pub. No.: US 2026/0219076 A1
(43) Pub. Date: Jul. 30, 2026

(54) SYSTEM TO MEASURE PUSHRIM PROPULSION DYNAMICS IN WHEELCHAIRS

(71) Applicants: University of Pittsburgh - Of the Commonwealth System of Higher Education, Pittsburgh, PA (US); The United States Government as Represented by the Department of Veterans Affairs, Washington, DC (US)

(72) Inventors: Rory Alan Cooper, Gibsonia, PA (US); Garrett G. Grindle, Pittsburgh, PA (US); Ian James Eckstein, Colorado Springs, CO (US); Joshua D. Brown, Pittsburgh, PA (US); Benjamin Todd Gebrosky, Gibsonia, PA (US); Brandon Joseph Daveler, Dunbar, PA (US); Jorge Luis Candiotti, Pittsburgh, PA (US)

(21) Appl. No.: 19/146,059

(22) PCT Filed: Jan. 7, 2024
(86) PCT No.: PCT/US2024/010606

§ 371 Date: Jul. 7, 2025

Related U.S. Application Data
(60) Provisional application No. 63/437,732, filed on Jan. 8, 2023.

(51) Int. Cl. G01D 5/347; A61G 5/02; A61G 5/10

(52) U.S. Cl. CPC G01D 5/34738; A61G 5/02; A61G 5/10; A61G 2203/32

(57) ABSTRACT

A device for measuring pushrim dynamics of a pushrim of a wheel of a wheelchair includes a plurality of beam sensing elements configured to be placed in connection with the pushrim. A sensor system of the device includes one or more sensors in connection with each beam sensing element to measure bending thereof. A modular hub of the device includes a mounting base which includes beam sensing element connectors to attach each of the beam sensing elements thereto to extend radially from the mounting base in a predetermined spaced relation. The modular hub further includes an inner hub flange configured to be removably connected on an inner side of the mounting base and an outer hub flange configured to be removably connected on an outer side of the mounting base. Each of the inner hub flange and the outer hub flange is configured to be operatively connected to the wheel.

### CROSS-REFERENCE TO RELATED APPLICATIONS

This application claims benefit of U.S. Provisional Patent Application Ser. No. 63/437,732, filed Jan. 8, 2023, the disclosure of which is incorporated herein by reference.

### BACKGROUND

The following information is provided to assist the reader in understanding technologies disclosed below and the environment in which such technologies may typically be used. The terms used herein are not intended to be limited to any particular narrow interpretation unless clearly stated otherwise in this document. References set forth herein may facilitate understanding of the technologies or the background thereof. The disclosure of all references cited herein are incorporated by reference.

A device, a later evolution of which was commercialized under the name SmartWheel, was developed in the 1980s to study the biomechanics and ergonomics of wheelchair activity through measurement of pushrim dynamics. See, for example, Cooper, R. A., SMARTWheel: From concept to clinical practice, Prosthetics and Orthotics International, 33 (3), 198-209 (2009), Cooper, R. A. and Cheda, A., Measurement of racing wheelchair propulsion torque, Images of the Twenty-First Century. Proceedings of the Annual International Engineering in Medicine and Biology Society, 1530-1531, (1989). Doi: 10.1109/IEMBS.1989.96324, and Asato, K. T., Cooper, R. A., Robertson, R. N., & Ster, J. F., SMART/sup Wheels: development and testing of a system for measuring manual wheelchair propulsion dynamics. IEEE Transactions on Biomedical Engineering, 40 (12), 1320-1324 (1993). Doi: 10.1109/10.250587, the disclosures of which are incorporated herein by reference. After approximately 20 years of production during which the SmartWheel device remained relatively unchanged, the manufacture of SmartWheel was discontinued.

### SUMMARY

In one aspect, a device for measuring pushrim dynamics of a pushrim of a wheel of a wheelchair includes a plurality of beam sensing elements configured to be placed in operative connection with the pushrim. The device further includes a sensor system including one or more sensors in connection with each of the plurality of beam sensing elements to measure bending of the beam sensing element. The device further includes a modular hub including a mounting base. The mounting base includes beam sensing element connectors to attach each of the plurality of beam sensing elements to the mounting base to extend radially from the mounting base in a predetermined spaced relation. The modular hub further includes an inner hub flange configured to be removably connected on an inner side of the mounting base and an outer hub flange configured to be removably connected on an outer side of the mounting base. Each of the inner hub flange and the outer hub flange is configured to be operatively connected to the wheel of the wheelchair. Each of the mounting base, the inner hub flange, and the outer hub flange independently including a passage therethrough via which a hub axle can be passed. In a number of embodiments, the inner hub flange includes a plurality of connectors configured to connect spokes of the wheel thereto, and the outer hub flange includes a plurality of connectors configured to connect spokes of the wheel thereto.

In a number of embodiments, the mounting base, the inner hub flange, and the outer hub flange are formed to be connected in a predetermined relative alignment. An internal surface of the passage of the mounting base may, for example, form a keyway, and one of an extending section of the inner hub flange or an extending section of the outer hub flange includes a key which cooperates with the keyway of the mounting base to provide a predetermined alignment between the mounting base and the one of the inner hub flange or the outer hub flange when the one of the extending section of the inner hub flange or the extending section of the outer hub flange is passed through the passage in the mounting base. The other of the extending section of the inner hub flange or the extending section of the outer hub flange includes a keyway which cooperates with the key of the one of the extending section of the inner hub flange or the extending section of the outer hub flange to provide a predetermined alignment therebetween.

The modular hub may further include a hub retainer which passes through the passage in one of the outer hub flange or the inner hub flange. The hub retainer includes threading to cooperate with threading on an interior wall of the passage of the other one of the inner hub flange and the outer hub flange to retain the inner hub flange and the outer hub flange in operative connection with the mounting base.

In a number of embodiments, the device further includes a plurality of isolation bearing cylinders. Each of the isolation bearing cylinders includes a seating for a distal section of one of the plurality of beam sensing elements. The seating includes a linear and rotary bearing system to cooperate with the one of the plurality of beam sensing elements. The device may further include a plurality of extending connectors. Each of the extending connectors is connected to (or is in operative connection with) one of the isolation bearing cylinders at a first end of the extending connector. A second end of the extending connector includes one or more spaced abutment members configured to contact the pushrim. The first end of the extending connector is connected to the distal end of the one of the isolation bearing cylinders via a rotary bearing. The beam sensing element seated in the seating of the one of the isolation bearing cylinders experiences substantially only bending forces arising from force placed on the pushrim. The linear and rotary bearing system may, for example, include a linear bushing.

In a number of embodiments, each of the plurality of beam sensing elements extends from the mounting base no more than 6 inches, or no more than 5 inches.

In a number of embodiments, the sensor system includes one or more sensors to determine speed of the wheel of the wheelchair and one or more sensors to determine orientation of the wheel of the wheelchair. The sensor system may, for example, include an encoder in operative connection with the hub axle.

In a number of embodiments, the device further includes electronic circuitry in connection with the sensor system and a base plate connected to the modular hub. The electronic circuitry may, for example, be attached to the base plate. In a number of embodiments, the electronic circuitry includes a processor system, a memory system, and a communication system.

In a number of embodiments, the electronic circuitry is configured to transmit data acquired in use of the device to an external computer system via the communication system. The data acquired may, for example, be transmitted wirelessly.

In a number of embodiments, the plurality of beam sensing elements includes three beam sensing elements, and the mounting base includes three beam sensing element connectors to attach each of the three beam sensing elements to the mounting base to extend radially therefrom relative to an axis of the hub axle with a spacing between axes of the three beam sensing elements of approximately 120 degrees.

In another aspect, a method of measuring pushrim dynamics of a pushrim of a wheel of a wheelchair includes replacing the hub of the wheel with a modular hub including a mounting base. The mounting base includes beam sensing element connectors to attach each of a plurality of beam sensing elements to the mounting base in a predetermined spaced relation. The mounting base further includes an inner hub flange configured to be removably connected on an inner side of the mounting base and an outer hub flange configured to be removably connected on an outer side of the mounting base. Each of the inner hub flange and the outer hub flange is configured to be operatively connected to the wheel of the wheelchair. Each of the mounting base, the inner hub flange, and the outer hub flange independently includes a passage therethrough via which a hub axle can be passed. Each of the plurality of beam sensing elements is configured to be placed in operating connection with the pushrim. Each of the plurality of beam sensing elements has one or more sensors of a sensor system in connection or operative connection therewith to measure bending of the beam sensing element. In a number of embodiments, the inner hub flange includes a plurality of connectors configured to connect spokes of the wheel thereto, and the outer hub flange includes a plurality of connectors configured to connect spokes of the wheel thereto. In a number of embodiments, the mounting base, the inner hub flange, and the outer hub flange are formed to be connected in a predetermined relative alignment.

In a number of embodiments, the method further include determining speed of the wheel of the wheelchair and determining orientation of the wheel of the wheelchair via one or more sensors of the sensor system. The speed and the orientation of the wheel of the wheelchair may, for example, be determined via an encoder in operative connection with the hub axle.

In a number of embodiments, data acquired via the sensor system is synchronized with data from one or more other sensor systems. The one or more other sensor systems may, for example, include at least one of an inertial measurement system and a motion capture system.

Electronic circuitry may, for example, be in connection with the sensor system. In a number of embodiments, the electronic circuitry includes a processor system, a memory system, and a communication system. The electronic circuitry may, for example, be configured to transmit data acquired via the sensor system to a computer system remote from the wheelchair via the communication system. The data acquired via the sensor system may, for example, be transmitted wirelessly. In a number of embodiments, data acquired via the sensor system, which is synchronized with data from one or more other sensor systems, is analyzed via the computer system remote from the wheelchair.

In a further aspect, a system includes a wheelchair including a first wheel including a first pushrim and a second wheel including a second pushrim. The system further includes a first device for measuring pushrim dynamics in operative connection with the first wheel and a second device for measuring pushrim dynamics in operative connection with the second wheel. Each of the first device and the second device includes a plurality of beam sensing elements configured to be placed in connection or operative connection with the first pushrim and the second pushrim, independently. The system also includes a sensor system including one or more sensors in connection with each of the plurality of beam sensing elements to measure bending of the beam sensing element. Each of the first and second devices further includes a modular hub including a mounting base. The mounting base includes beam sensing element connectors to attach each of the plurality of beam sensing elements to the mounting base to extend radially from the mounting base in a predetermined spaced relation. The mounting base further includes an inner hub flange configured to be removably connected on an inner side of the mounting base and an outer hub flange configured to be removably connected on an outer side of the mounting base. Each of the inner hub flange and the outer hub flange is configured to be operatively connected to the first wheel and the second wheel of the wheelchair, independently. Each of the mounting base, the inner hub flange, and the outer hub flange independently includes a passage therethrough via which a hub axle can be passed.

The system may further include electronic circuitry in connection with the sensor system. The electronic circuitry may, for example, include a processor system, a memory system, and a communication system. In a number of embodiments, the electronic circuitry is configured to transmit data acquired via the sensor system to a computer system remote from the wheelchair via the communication system. The data acquired via the sensor system may, for example, be transmitted wirelessly. The data acquired via the sensor system may, for example, be synchronized with data from one or more other sensor systems. The data acquired via the sensor system and the one or more other sensor systems may be analyzed via the computer system remote from the wheelchair.

The present devices, systems, and methods along with the attributes and attendant advantages thereof, will best be appreciated and understood in view of the following detailed description taken in conjunction with the accompanying drawings.

### BRIEF DESCRIPTION OF THE DRAWINGS

FIG. 1A illustrates an embodiment of a device hereof used in connection with an ultralight wheelchair wheel with a standard pushrim.

FIG. 1B illustrates an embodiment of a device hereof used in connection with a racing wheelchair wheel.

FIG. 2A illustrates an inner (that is, showing the side of the device hereof facing the wheelchair) isometric view (left) without protective covers, an outer isometric view without protective covers, and an outer isometric view with protective covers of the wheelchair wheel and connected device of FIG. 1A.

FIG. 2B illustrates another isometric view of the device FIG. 1A in operative connection with the wheelchair wheel of FIG. 1A with inner and outer protective covers aligned for connection with the device and wheelchair wheel.

FIG. 2C illustrates a system hereof including a wheelchair including the wheelchair wheels and devices of FIG. 1A.

FIG. 3A illustrates an exploded isometric view of an embodiment of a self-locking hub design of the device of FIG. 1A.

FIG. 3B illustrates an assembled isometric view of the self-locking hub of FIG. 3A.

FIG. 3C illustrates an exploded isometric view of another embodiment of a self-locking hub design of a device hereof.

FIG. 3D illustrates an assembled isometric view of the self-locking hub of FIG. 3C.

FIG. 4 illustrates another inner isometric view of the device hereof in operative connection with the rim and spokes of the wheelchair wheel of FIG. 1A.

FIG. 5 illustrates an enlarged, isometric inner view of a portion of the device of FIG. 4 showing components of the device.

FIG. 6 illustrates an enlarged, isometric outer view of the device of FIG. 4 showing components of the device.

FIG. 7 illustrates a flow chart for synchronized data acquisition in real time and post processing data analysis for a system hereof.

### DETAILED DESCRIPTION

It will be readily understood that the components of the embodiments, as generally described and illustrated in the figures herein, may be arranged and designed in a wide variety of different configurations in addition to the described representative embodiments. Thus, the following more detailed description of the representative embodiments, as illustrated in the figures, is not intended to limit the scope of the embodiments, as claimed, but is merely illustrative of representative embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

As used herein and in the appended claims, the singular forms “a,” “an,” and “the” include plural references unless the context clearly dictates otherwise. Thus, for example, reference to “a beam sensing element” includes a plurality of such beam sensing elements and equivalents thereof known to those skilled in the art, and so forth, and reference to “the beam sensing element” is a reference to one or more such beam sensing elements and equivalents thereof known to those skilled in the art, and so forth. Recitation of ranges of values herein are merely intended to serve as a shorthand method of referring individually to each separate value falling within the range. Unless otherwise indicated herein, each separate value, as well as intermediate ranges, are incorporated into the specification as if individually recited herein. All methods described herein can be performed in any suitable order unless otherwise indicated herein or otherwise clearly contraindicated by the text.

The terms “electronic circuitry,” “circuitry” or “circuit,” as used herein include, but is not limited to, hardware, firmware, software, or combinations of each to perform a function(s) or an action(s). For example, based on a desired feature or need, a circuit may include a software-controlled microprocessor, discrete logic such as an application specific integrated circuit (ASIC), or other programmed logic device. A circuit may also be fully embodied as software. As used herein, “circuit” is considered synonymous with “logic.” The term “logic,” as used herein includes, but is not limited to, hardware, firmware, software, or combinations of each to perform a function(s) or an action(s), or to cause a function or action from another component. For example, based on a desired application or need, logic may include a software-controlled microprocessor, discrete logic such as an application specific integrated circuit (ASIC), or other programmed logic device. Logic may also be fully embodied as software.

The term “processor,” as used herein includes, but is not limited to, one or more of virtually any number of processor systems or stand-alone processors, such as microprocessors, microcontrollers, central processing units (CPUs), and digital signal processors (DSPs), in any combination. The processor may be associated with various other circuits that support operation of the processor, such as random-access memory (RAM), read-only memory (ROM), programmable read-only memory (PROM), erasable programmable read only memory (EPROM), clocks, decoders, memory controllers, or interrupt controllers, etc. These support circuits may be internal or external to the processor or its associated electronic packaging. The support circuits are in operative communication with the processor. The support circuits are not necessarily shown separate from the processor in block diagrams or other drawings.

The term “controller,” as used herein includes, but is not limited to, any circuit or device that coordinates and controls the operation of one or more input and/or output devices. A controller may, for example, include a device having one or more processors, microprocessors, or central processing units capable of being programmed to perform functions.

The term “software,” as used herein includes, but is not limited to, one or more computer readable or executable instructions that cause a computer or other electronic device to perform functions, actions, or behave in a desired manner. The instructions may be embodied in various forms such as routines, algorithms, modules, or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, or the desires of a designer/programmer or the like.

As used herein, the term “personal communications device” refers to a portable or mobile device which includes a communication system, a processor system, a user interface system (for example, a visual feedback system including a touchscreen or other display, an auditory feedback system, and a tactile feedback system, a user input system etc.) and an operating system capable of running general-purpose applications. Examples of personal communications devices include, but are not limited to, smartphones, tablet computer and custom devices. As used herein, the term “tablet computer” or tablet, refers to a mobile computer with a communication system, a processor system, at least one user interface as described above (typically including a touchscreen display), and an operating system capable of running general-purpose applications in a single unit. As used herein, the term “smartphone” refers to a cellular telephone including a processor system, at least one user interface as described above (typically including a touchscreen display), and an operating system capable of running general-purpose applications. Such personal communication devices are typically powered by rechargeable batteries and are housed as a single, mobile unit. Moreover, in a number of embodiments personal communications devices are able accept input directly into a touchscreen (as opposed to requiring a keyboard and/or a mouse). Personal communications devices as typically provide for internet access through cellular networks and/or wireless internet access points connected to routers.

Although SmartWheel devices are no longer manufactured, there remains a need for devices, systems, and methods to measure pushrim dynamics in, for example, research and clinical settings. As set forth above, the basic design of the SmartWheel device remained largely unchanged for the approximately 20 years it was in production. The present inventors have identified a number of limitations of that device that would limit its application in meeting current needs. For example, the device was limited to a single type and size of wheelchair wheel. Moreover, the device was relatively heavy and was practically limited to use in connection with stationary rollers or treadmills.

The devices, systems, and methods hereof are designed to accommodate multiple types of wheelchairs (for example, multiple types of sports wheelchairs) with different wheel, hub, and pushrim sizes. The devices, systems, and methods hereof are also suitable for use in overground motion/applications. The devices, systems, and methods hereof also permit higher speeds of propulsion (for example, up to 30 mph (48.3 km/hr)), and are lighter in weight (thereby, for example, reducing effect during overground motion).

Manual wheelchairs provide important means of mobility and function. Such wheelchairs are used for a wide variety of activities ranging from daily mobility to exercise, to recreation, to sports, and more. The ability to optimize the design of various manually propelled wheelchairs for specific activities and to optimize their fit and interaction with their user requires knowledge of ergonomics, design, and task or activity and environment knowledge. An important component for optimizing fit and wheelchair/user interaction is the ability to measure how and where forces and moments are applied to the wheelchair pushrims. In a number of embodiments, the devices, systems, and method hereof include a modular design to measure wheelchair motion parameters at the wheels and a single core design to accommodate a variety of wheelchairs (including, for example, ultralight daily use wheelchairs, children's wheelchairs, basketball wheelchairs, tennis wheelchairs, racing wheelchairs, etc.). The unique design of the devices hereof allows those devices to be readily used with different wheel and pushrim types and sizes.

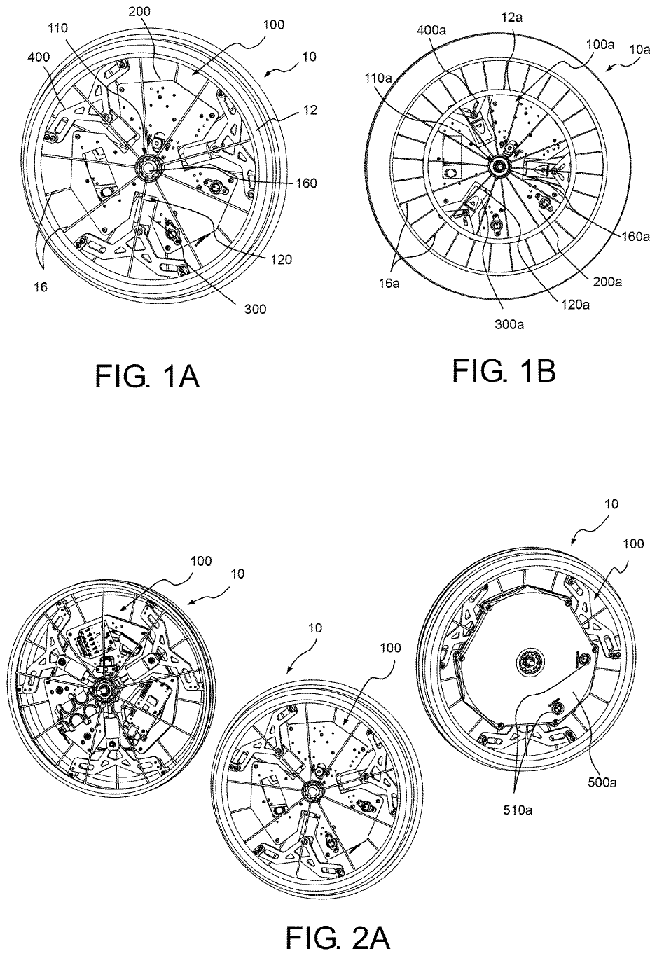

Three representative device hereof were fabricated (two versions for racing wheelchairs and one for ultralight wheelchairs) for study. FIG. 1A illustrated a device 100 hereof in operative connection with an ultralight wheelchair wheel 10 having a standard pushrim. FIG. 1B illustrates an embodiment of a device 100a hereof in operative connection with a racing wheelchair wheel 10a. Components of wheelchair wheel 10a and device 100a, as illustrated in FIG. 1B, are numbered similarly to like components of wheelchair wheel 10 and device 100 with the designation “a” added to the end of the reference. Wheelchairs for basketball, rugby, and tennis require only small variations of the ultralight wheelchair version illustrated in FIGS. 1A and 1B. In that regard, the primary difference between wheelchairs for such uses and the ultralight version of the device illustrated in FIG. 1A include the rim size, which is typically 26 inch (66 cm) in diameter for basketball, tennis, and rugby as compared to a 24 inch (61 cm) in diameter for ultralight, daily use manual wheelchairs. Sports wheelchairs also use high angles of camber. In a number of embodiments, the angle of camber of representative wheels thereof may, for example, be up to 20 degrees from vertical. Such an angle of camber places side-loads on the wheels, especially on rims, spokes, and hubs. The devices hereof are readily designed to withstand such loads. Racing wheelchairs use 26 inch (66 cm), 700 c, or 27 inch (68.6 cm) wheels commonly with aerodynamic rims (see FIG. 1B).

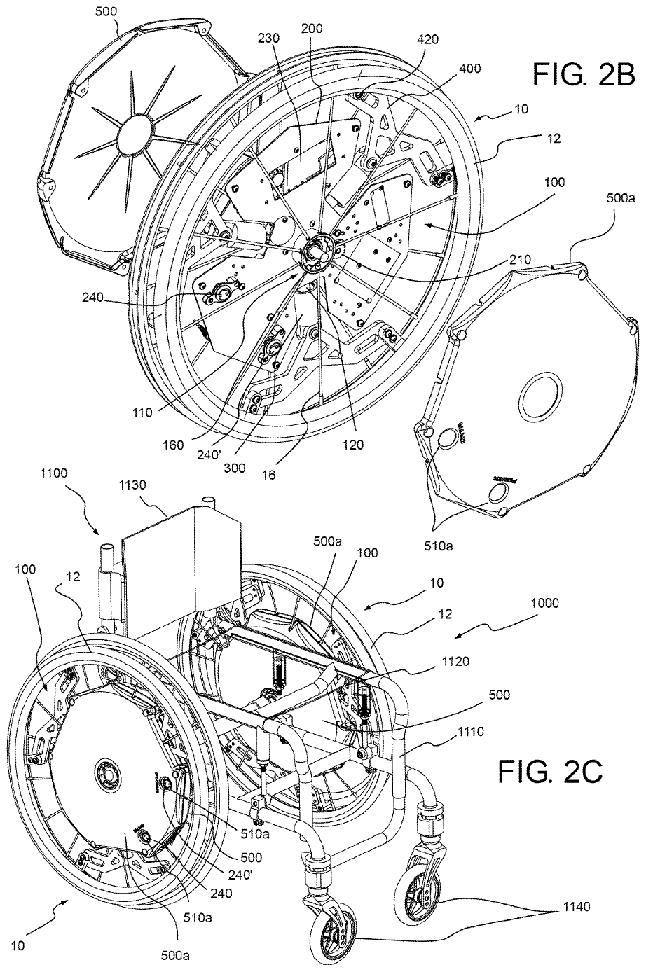

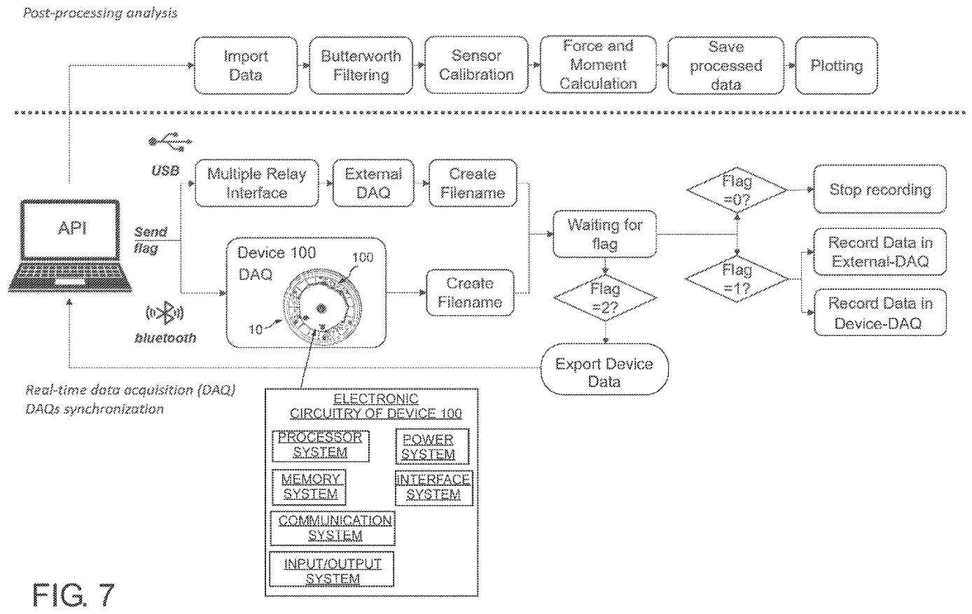

Device 100 for use with a wheel 10 of a wheelchair 1100 of a wheelchair system 1000 (see FIG. 2C) is further illustrated in FIGS. 2A through 6. A flow chart for real-time data acquisition and post-processing analysis for a device hereof such as device 100 is illustrated in FIG. 7. Typically (as illustrated in FIG. 2C), a separate device 100 hereof is placed in connection with each of wheels 10 of wheelchair 1100 in measuring/studying pushrim dynamics. As illustrated in FIG. 2C, and as known in the wheelchair arts, wheelchair 1100 includes a frame 1110. A seat 1120 (illustrated as transparent in FIG. 2C) and a backrest 1130 are in connection with frame 1110. Caster wheels 1140 are connected to frame 1110 on a forward section thereof and wheels 10, which operate as drive wheels, are connected to frame 1110 on a rearward section thereof.

Pushrims such as pushrim 12a of FIG. 1B used for racing wheelchairs vary, for example, from 14 inches (35.6 cm) to 18 inches (45.72) in diameter and use a relatively small tubing diameter (often around ⅜ inch (0.953 cm)). Devices 100, 100a hereof are able to accommodate a large pushrim diameter range (for example, but not limited to, ranging from 14 inch (35.6 cm) to 24 inch (61 cm)). To facilitate the use of devices 100, 100a hereof with a broad range of diameters, a modular hub 110. 110a (which replaces the original wheel hub of a wheelchair wheel) is provided wherein the hub size and weight are reduced or minimized while the stiffness is increased or maximized (for example, as compared to the previously available SmartWheel device).

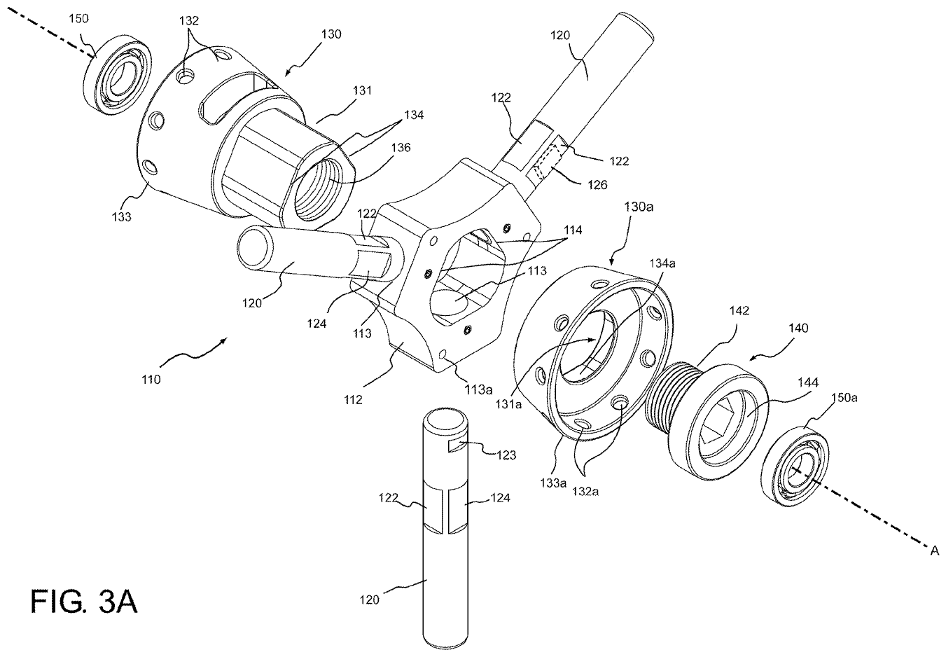

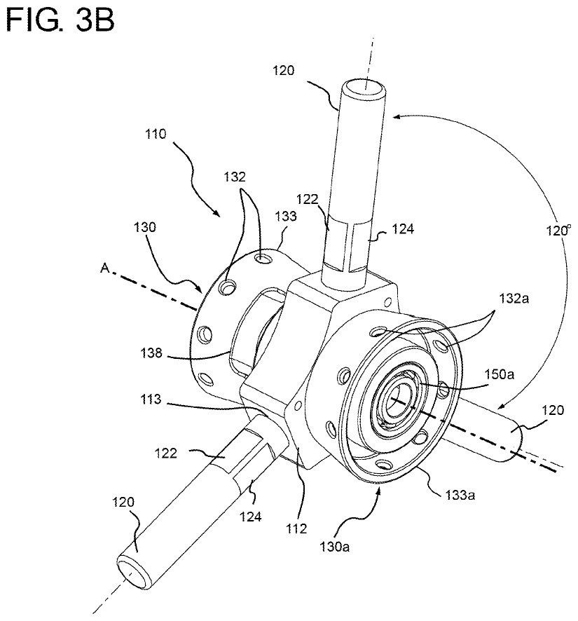

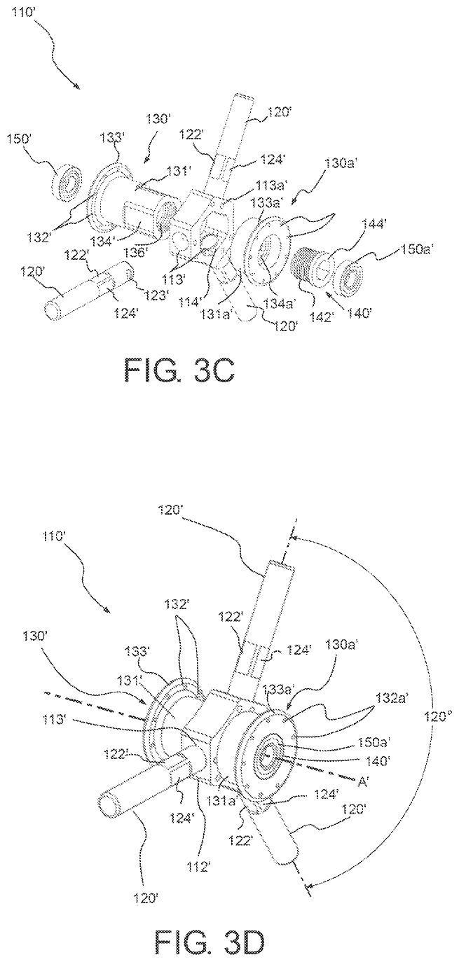

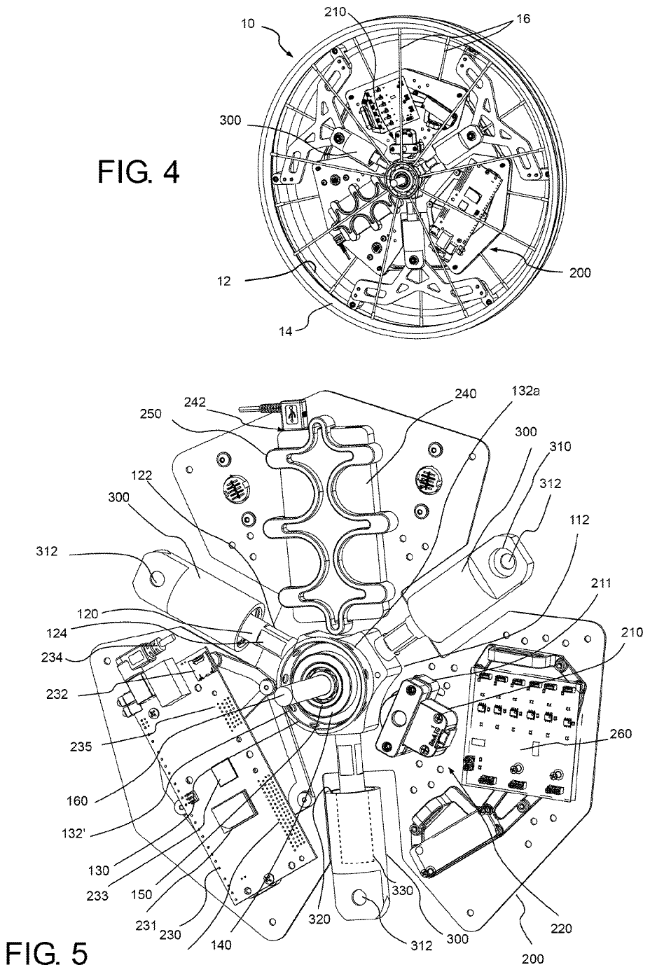

In device 100, which is representative of other devices hereof, a mounting base 112 of a hub or sensing hub 110 (see FIGS. 3A and 3B) is, for example, formed from high strength titanium alloy and is used to mount or connect beam sensing elements 120 to sensing hub 110. Beam sensing elements 120 extend radially (relative to the axis of sensing hub 110 and the wheel axis) from sensing hub 110. To meet the needs of the various types of manually propelled wheelchairs, devices hereof such as representative device 100 were fabricated such that hub or sensing hub 110 is modular. In the illustrated embodiments, mounting base 112 includes connectors 113 (for example, including passages, holes or seatings) via which each of a plurality of beam sensing elements or sensing beams 120 are attachable in predetermined relative position and orientation. Typically, at least three sensing beams 120 are provided. In the illustrated embodiment, sensing beams 120 extend radially from the mounting base 112 and are approximately equidistantly spaced (that is, 120 degrees apart in the case of three sensing beams) via passages 113 about the circumference of mounting base 112. As used herein, “approximately” indicates that the values is within 5% of, or more typically within 1% of a stated value. In the illustrated embodiment, mounting base 112 further includes passages 113a (see FIG. 3A) via which retaining screws or other connectors can be inserted to cooperate with seating 123 of beam sensing elements 120 and secure connection of beam sensing elements 120. Mounting base 112 of sensing hub 110 may, for example, be a common element (or the same) for all devices 100 hereof. Inner/internal hub flange 130 and outer/external hub flange 130a of sensing hub 110 may, for example, be wheel-specific and include connectors such as passages 132 and 132a, respectively, formed on a extending flange sections or members 133 and 133a thereof to form a connection with wheel spokes 16 (see, for example, FIGS. 3A through 4) to sensing hub 110. Hub flanges 130 and 130a (which may include connecting components common between embodiment to interface with common mounting base 112 and form the assembly of modular hub 110 as described herein) are selected to interface with a particular wheel diameter, type, etc. As used herein, the terms “internal” and “external” and like terms refer to a direction toward an interior portion or lateral centerline of the wheelchair and away from the centerline wheelchair, respectively. Passages/connectors 132, 132a may, for example, be optimized for the number of spokes in a wheel (generally 18-32 spokes), for the type of spoke (steel, aluminum, composite, round profile, bladed profile), the size spokes, a spoke connector type, and the length of the spokes (see, for example, FIGS. 2 through 4). Device 100 further includes high strength and high stiffness connecting elements or connectors (which are wheel/pushrim specific and are further described below) that connect or operatively connect pushrim 12 to sensing beams 120. The components of device 10 make it possible to use a common sensing element (including, sensing beams 120) between devices and yet accommodate a range of diameters and type of pushrims.

Beam sensing elements 120 are instrumented with a sensor system including one or more sensors such as strain gages 126 (one of which is illustrated schematically in broken lines in FIG. 3A). In that regard, as, for example, illustrated in FIG. 3B, each beam sensing element 120 has four flat areas for positioning and retention of strain gages. Two flat areas 122 are positioned on opposite sides of beaming sensing elements 120. The planes of flat areas 122 on each beam sensing element 120 are oriented generally (for example, within 5% or, more typically, within 1% of) parallel or parallel to each other. Two other flat areas 124 are also positioned on opposite sides of each beam sensing element 120. The planes of flat areas 124 on each beam sensing element 120 are also oriented generally parallel or parallel to each other. The planes of flat areas 122 are oriented generally orthogonal or orthogonal to the planes of flat areas 124. Strain gages 126 operatively connected to flat areas 122 and 124 measure bending in beam sensing elements 120 (resulting from a user pushing on pushrim 12) in the plane of rotation of wheel 10 and inward/outward of (or orthogonal to) that plane of rotation, respectively.

In the representative embodiment illustrated in FIG. 3A, internal flange 130 includes an extending connective section 131 that includes flat surfaces 134 (three in the illustrated embodiment) which form a key. An internal surface of mounting base 112 (see FIG. 3B) includes matching flat surfaces 114 which form an internal keyway to match the key of internal flange 130. In the illustrated embodiment, the key of internal flange 130 also matches or mates with an internal keyway including flat surfaces 134a on an internal surface external of an extending connective section 131a of hub flange 130a. Threading 142 of a hub retaining fastener 140 cooperates with internal threading 136 of extending connective section 131 of internal flange 130 in the illustrated embodiment to lock internal flange 130, mounting base 110, and external flange 130a together in a determined relative orientation (as determined by cooperating keys/keyways as described above). An internal hub bearing 150 is seated within the internal passage (not shown) of internal flange 130, and an external hub bearing 150a is seated within the internal passage 144 of hub retaining fastener 140 to cooperate with and allow free rotation of hub axle 160 (see, for example, FIG. 5).

FIGS. 3C and 3D illustrate another embodiment of a sensing hub 110′ hereof which is constructed and functions is a manner very similar to sensing hub 110. Components of sensing hub 110′ are numbered similarly to like components of sensing hub 110 with the designation “′” added to the end of the reference numeral. In the case of internal hub 130 and external hub 130a, extending flange sections 133 and 133a, respectively, extend both axially and radially from connective sections 131 and 131a (relative to axis A of sensing hub 110). In the case of internal hub 130′ and external hub 130a′, extending flange sections 133′ and 133a′, respectively, extend radially from connective sections 131′ and 131a′ (relative to axis A′ of sensing hub 110′).

As clear to one skilled in the art, other manners of assembling the components of the modular hub/modular hub assembly hereof may be used as, for example, known in the mechanical engineering arts. For example, other combinations of keys/keyways and connector elements can be used to accomplish connection in a predetermined orientation. In general, the mounting base hereof maintains the beam sensing elements in proper orientation (that is, for example, extending radially relative to the hub axle and being spaced approximately equidistantly). Moreover, the internal hub and the external hub interactively and operatively connect with the mounting base and with each other to provide relative alignment thereof suitable to operatively connect with, for example, the spokes of the wheel.

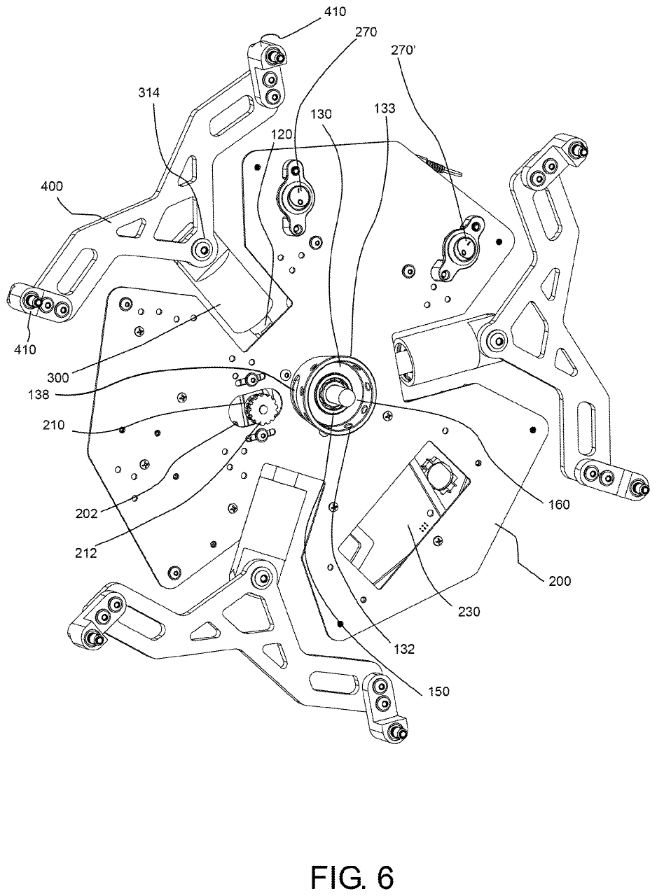

An embodiment of electronics/electronic circuitry of device 100 is illustrated schematically in FIG. 7. Components of the electronic circuitry of device 100 may, for example, be positioned upon a base or base plate 200. In a number of embodiments, base plate 200 was formed from high-strength carbon fiber. A sensor system including one or more sensors is provided to determine the speed and orientation of wheel 10. In a number of embodiments, an encoder sensor such as a rotary optical encoder 210 is used to measure wheels speed and orientation, which is used to translate the rotating, wheel-centric coordinate system to a user or fixed in space “global” coordinate system as well as to determine essential wheelchair propulsion dynamics (that is, speed, direction, push-angle, distance traveled, etc.) See, for example, FIGS. 5 and 6. An encoder mounting bracket 211 is provided to connect encoder 210 to base plate 200 (see FIG. 5). Gear 212 is in operative connection with encoder 210 via a slot 202 formed in base plate which may be used to appropriately tension a timing belt. A gear (not shown) is included in operative connection with axle 160 which drives an encoder gear 210 via, for example, a belt drive (not shown) which passes through a slot 138 in internal flange 130.

The electronic circuitry of device 10 further includes encoder circuitry 220 for encoder 210 positioned on base plate 200. In a number of embodiments, a computer system such as a singled PCB (printed circuit board) computer system 230 is also attached to base plate 200. Such a computer system may, for example, include a processor system (for example, including one or more microprocessors), a memory system, a communication system (for example, for at least one or wired and wireless communication), etc. as known in the computer arts and as illustrated schematically in FIG. 7. Electronic circuitry further includes a power system such as a battery system 240 which also may be attached to base plate 200 via a retainer 250 to power the components of electronic circuitry of device 210. In a number of studied embodiments, battery system had a capacity of 5000 mAh and was charged via a USB port 242 (see FIG. 5). Battery system 240 supplies power to electronic circuitry including, for example, circuit board/computer system 230, encoder/encoder system 210 and strain gauge acquisition amplifier circuit board 260.

As illustrated in the embodiment of FIG. 5, circuit board/computer system 230 includes a microprocessor 231 (which was a TEENSY® 3.6 USB Development Board, available from PJRC.COM LLC of Sherwood, Oregon US, in a number of studied embodiments) with a built-in micro-sd card reader 232 to read and record sensor values, a BLUETOOTH module 233 (HC-05) to, for example, transmit data including for synchronization with other data acquisition boards/devices, a power input 234 that connects with battery system 240, a connector 235 to interface with encoder 210 (an S1 incremental quadrature encoder, available from US Digital of Vancouver, Washington US, in a number of embodiments) and a connector for customized strain gauge circuit amplifier 260. The strain gauge circuit amplifier receives the strain gauge values which are multiplied by a constant and then sent to the circuit board for storage.

One or more on/off actuators, for example, one or more buttons or switches 240 and 240′ (as illustrated in, for example, FIG. 6) can, for example, be provided in operative connection with the electronic circuitry. In a number of embodiments, such on/off buttons or switches are provided on outer covers 500a or, alternatively, passages 510a may be provided through outer covers 500a to provide access to on/off buttons or switches 270 and 270′ positioned on base plate 200 (see, for example, FIGS. 2A through 2C). In the illustrated embodiment, switch 270′ turns on/off circuit board/computer system 230, switch 270 is a data switch that starts/stops recording data when device 100 is used independently and not synchronized with other devices.

In a number of embodiments, single board computer system 230 is used to collect signals from a sensor system including, for example, sensors operatively connected to sensing beams 120 and encoder 210. Such data may be buffered and transmitted wirelessly or in a wired manner to an external device (for example, a computer, a personal communication device, such as a smartphone or tablet, etc.) for data storage and analysis. Such data may be used independently or be synchronized with data from one or more other devices/systems. One or more software algorithms (which may be stored in the memory system associated computer system 230, on a remote computer system, or be distributed) permit data to be analyzed in real-time for coaching or learning and/or stored an analyzed later for more in-depth analysis as further described below.

As illustrated in, for example, FIGS. 5 and 6, each of beam sensing elements 120 are placed in operative connection with pushrim 12 via an isolation bearing cylinder 300 which is operatively connected to connectors or extending connector 400 which extends between isolation bearing cylinder 300 and pushrim 12. Connectors 400 are selected to interface with a specific pushrim diameter, type etc. In the illustrated embodiment of device 10, connector 400 (which is generally triangular in shaped and formed from a stiff, carbon-fiber material in the illustrated embodiment) includes a plurality of spaced standoffs 410 (two in the illustrated embodiment) which contact or abut pushrim 12. In a number of embodiments, each of connectors 400 is attached to a corresponding one of isolation bearing cylinder through a rotary bearing seated in a pocket or seating 310 of the isolation bearing cylinder 300. A connector passes through a passage 312 in isolation bearing cylinder 314 (see, FIG. 6) to attached extending connector 400 thereto.

At the end of isolation bearing cylinder 300 opposite to the end which connected to extending connector 400, an opening leads to a pocket or seating 320 (see FIG. 5) to receive a radially distal end section of beam sensing element 120. Seating 320 includes a linear/rotary bushing or bearing 330 (illustrated schematically in broken lines in FIG. 5). In one embodiment, a TEFLON-faced linear bushing was used. The use of a bushing rather than, for example, a recirculating ball linear bearing is facilitated was facilitated by a hardened, anodized surface on aluminum beam sensing elements 120. The combination of extending connector 400, isolation bearing cylinder 300, and associated bearings and/or bushings ensure that beam sensing elements 120 experience only bending.

Lightweight inner cover 500 and outer cover 500a connect to form a cover to protect sensitive instruments/component while allowing easy access. See, for example, FIGS. 1 and 2A through 2C. Covers 500 and 500a may, for example, be connected via connectors such as screws or bolts which pass through passages in inner cover 500, base plate 200, and outer cover 500a.

Compared to the sensing beams or beam sensing elements of the previously available SmartWheel device, sensing beams or beam sensing elements 120 of device 10 are shorter to accommodate a broad range of wheel and pushrim sizes (see, for example, FIG. 4). The relatively short length of beam sensing elements 120 of device 10 enable the manufacture of such beam sensing elements 120 from aluminum alloy with a hard anodized finish, thereby reducing or minimizing weight. The steel beam sensing element in the SmartWheel device were approximately 8 inches (20.3 cm) in length while aluminum alloy beam sensing elements 120 are approximately 5 inches (12.7 cm) in length. The lighter material and decreased length of beam sensing elements 120 significantly reduce weight. Further, the modular sensing hub 100 was approximately 2.5 inches (6.4 cm) in diameter as compared to the dedicated, non-modular machined aluminum disk (which had a diameter of approximately 8 inches (20.3 cm)) used in the previously manufactured Smart Wheel device.

As described above, the polished hard anodized finish also permits the use of sliding (versus circulating rolling) linear bushings, which provide the simultaneous function of acting as a rotational bearing about center axis of beam sensing element 120 (see, for example, FIG. 5). The use of linear bushings reduces weight and saves space.

Mounting of electronic circuitry/components on a single, integrally formed carbon fiber base plate 200 reduces the effect of shock and vibration on leads and connectors. The electrical components may, for example, be held securely in place with 3D printed Nylon custom brackets.

In summary, device 100 provides a unique compact modular hub design that provides for use with wheels of various sizes (for example, 22″ (55.9 cm), 24″ (61 cm), 25″ (63.5 cm), 700 c, 26″ (66 cm), 27″ (68.6 cm)), styles (for example, standard, impact, aerodynamic), and camber angles. Likewise, the unique, compact modular hub design provides for use with pushrims of various sizes (for example, 14-24 inch (35.6-61 cm) diameter), styles (for example, racing, standard, ergonomic). The mounting brackets or extending connectors hereof (which may be formed from carbon fiber material) permit attachment of various pushrim types (for example, standard, ergonomic, racing, rugby, etc.) and sizes. The total mass/weight of device 10 is minimized or optimized to minimize altering of propulsion dynamics during overground propulsion. In a number of embodiments, device 10 had a weight of no more than 4 pounds (1.81 kg) or no more than 3 pounds (1.36 kg), while the previously available SmartWheel device had a weight of approximately 10 pounds (4.53 kg). A high data sampling rate supports study of high-speed activities such as racing. Long lasting batteries may be used to permit lengthier data collection periods. Data buffering and transmitting to a remote system allows fast sampling and long date collection periods. Moreover, remote sensing may provide real-time viewing of overground or on-court activities. Some of the type of data that can be measured and processed by device 100 is, for example, described in Cooper, R. A. and Cheda, A., Measurement of racing wheelchair propulsion torque, Images of the Twenty-First Century. Proceedings of the Annual International Engineering in Medicine and Biology Society, 1530-1531, (1989). doi: 10.1109/IEMBS.1989.96324, and Asato, K. T., Cooper, R. A., Robertson, R. N., & Ster, J. F., SMART/sup Wheels: development and testing of a system for measuring manual wheelchair propulsion dynamics. IEEE Transactions on Biomedical Engineering, 40 (12), 1320-1324 (1993). doi: 10.1109/10.250587.

As, for example, illustrated in FIG. 7, in a number of studies, a representative application programming interface (API), developed in MATLAB® R2021 (a software environment of engineering and science available from MathWorks, Inc. of Natick, Massachusetts US), enables the synchronization of the device(s) 100, 100a, and other devices hereof and one or more other external devices (for example, motion capture, an inertial measurement unit (IMU), development board, etc.) for synchronized data acquisition (DAQ) in real-time and post-processing data analysis. As illustrated in FIG. 7, a computer storing/executing the API may, for example, be connected to device 100 wirelessly (for example, via BLUETOOTH®) and the one or more external devices may, for example, be connected via USB port and a relay interface. In the illustrated embodiment, the API first searches for a communication module or system of device 100 such as a BLUETOOTH module assigned to device(s) 100. BLUETOOTH is a wireless technology that provides for the exchange of data between different devices of The Bluetooth SIG, Inc., a standards organization that oversees the development of BLUETOOTH standards. After that, the API requests a user input, translated into a flag, to start (flag=0) or stop (flag=1) recording data in one or both devices 100 in a system such as system 1000. The relay interface is used as digital switch to start/stop data recording in the external device. Device 100 and external device data may, for example, be recorded as a *.csv or *. txt file locally in their respective storage units. If recording is completed, the device data can be exported (flag=2) to the computer via BLUETOOTH.

In synchronized data acquisition (or synchronized DAQ), synchronization with data acquisition of one or more other devices (for example, external/remote devices or other internal/wheelchair connected devices) occurs to, for example, show the same starting/ending timestamps. Device 100 DAQ may, for example, be synchronized with a motion capture system (for example, a VICON system available from Vicon Motion Systems of Los Angeles, California US) to measure wheelchair user kinetics during manual wheelchair propulsion to improve propulsion efficiency and performance. Motion capture systems may, for example, include cameras, initial sensors, and/or other devices. A computer including the device 100 API may, for example, synchronize the motion capture and device 100 DAQ via USB and BLUETOOTH, respectively.

In another representative example, Inertial Measurement Unit (IMU) data acquisition/DAQ (for example, using IMUs such as XSENS®, available from Movella Holdings B.V, of Enshede, Netherlands, or the SHIMMER 3 IMU available from Shimmer Research of Cambridge, Massachusetts US) can be paired with the device 100 DAQ via BLUETOOTH to measure the energy expenditure on different surfaces. The IMU DAQ records the inclination of the surface and vibration exposure while device 100 measures the exerted forces translated into energy and the traveled distance during this task. As clear to those skilled in the art, synchronizing data acquisition with other devices enables expanded data analysis for use in, for example, consideration of environmental factors (for example, surface slopes etc.), kinematics, inverse kinematics, etc.

For post-processing data analysis, the device data file may, for example, include raw strain gauges values, encoder values, timestamp(s), etc. In the studied embodiment, the data is imported to a MATLAB script which filters out sensors noise and outliers using, for example, Butterworth filtering. A Butterworth filter is a signal processing filter which is designed to provide a frequency response that is as flat as possible in the passband. The sensor values are calibrated by setting the baseline of each sensor when the DAQ begins. The encoder values are used to calculate the device speed and angle in reference to one of the strain gauges and ground. Forces in each axis are calculated from strain gauge values after performing a static sensor calibration. The forces are combined with the device angle to calculate the axial and tangential total forces and moments of each device 100. Those values may, for example, be plotted and stored in a *.csv file for further analysis and interpretation.

The foregoing description and accompanying drawings set forth a number of representative embodiments at the present time. Various modifications, additions and alternative designs will, of course, become apparent to those skilled in the art in light of the foregoing teachings without departing from the scope hereof, which is indicated by the following claims rather than by the foregoing description. All changes and variations that fall within the meaning and range of equivalency of the claims are to be embraced within their scope.

1. A device for measuring pushrim dynamics of a pushrim of a wheel of a wheelchair, comprising:
a plurality of beam sensing elements configured to be placed in operative connection with the pushrim,
a sensor system comprising one or more sensors in connection with each of the plurality of beam sensing elements to measure bending of the beam sensing elements; and
a modular hub comprising a mounting base, the mounting base comprising beam sensing element connectors to attach each of the plurality of beam sensing elements to the mounting base to extend radially from the mounting base in a predetermined spaced relation, an inner hub flange configured to be removably connected on an inner side of the mounting base, and an outer hub flange configured to be removably connected on an outer side of the mounting base, each of the inner hub flange and the outer hub flange being configured to be operatively connected to the wheel of the wheelchair, each of the mounting base, the inner hub flange, and the outer hub flange independently comprising a passage therethrough via which a hub axle can be passed.

2. The device of claim 1 wherein the inner hub flange comprises a plurality of connectors configured to connect spokes of the wheel thereto, and the outer hub flange comprises a plurality of connectors configured to connect spokes of the wheel thereto.

3. The device of claim 2 wherein the mounting base, the inner hub flange, and the outer hub flange are formed to be connected in a predetermined relative alignment.

4. The device of claim 2 wherein an internal surface of the passage of the mounting base forms a keyway and one of an extending section of the inner hub flange or an extending section of the outer hub flange comprises a key which cooperates with the keyway of the mounting base to provide a predetermined alignment between the mounting base and the one of the inner hub flange or the outer hub flange when the one of the extending section of the inner hub flange or the extending section of the outer hub flange is passed through the passage in the mounting base, the other of the extending section of the inner hub flange or the extending section of the outer hub flange including a keyway which cooperates with the key of the one of the extending section of the inner hub flange or the extending section of the outer hub flange to provide a predetermined alignment therebetween.

5. The device of claim 3 wherein the modular hub further comprises a hub retainer which passes through the passage in one of the outer hub flange or the inner hub flange, the hub retainer comprising threading to cooperate with threading on an interior wall of the passage of the other one of the inner hub flange and the outer hub flange to retain the inner hub flange and the outer hub flange in operative connection with the mounting base.

6. The device of claim 1 further comprising a plurality of isolation bearing cylinders, each of the isolation bearing cylinders comprising a seating for a distal section of one of the plurality of beam sensing elements, the seating comprising a linear and rotary bearing system to cooperate with the one of the plurality of beam sensing elements, and a plurality of extending connectors, each of the extending connectors being connected to one of the isolation bearing cylinders at a first end of the extending connector, a second end of the extending connector comprising one or more spaced abutment members configured to contact the pushrim, the first end of the extending connector being connected to the distal end of the one of the isolation bearing cylinders via a rotary bearing, whereby the beam sensing element seated in the seating of the one of the isolation bearing cylinders experiences substantially only bending forces arising from force placed on the pushrim.

7. The device of claim 6 wherein the linear and rotary bearing system comprises a linear bushing.

8. The device of claim 6 wherein each of the plurality of beam sensing elements extends from the mounting base no more than 6 inches.

9. The device of claim 8 wherein each of the plurality of beam sensing elements extends from the mounting base no more than 5 inches.

10. The device of claim 6 wherein the sensor system further comprises at least one of one or more sensors to determine speed of the wheel of the wheelchair and one or more sensors to determine orientation of the wheel of the wheelchair.

11. The device of claim 10 wherein the sensor system comprises an encoder in operative connection with the hub axle.

12. The device of claim 10 further comprising electronic circuitry in connection with the sensor system and a base plate connected to the modular hub, the electronic circuitry being attached to the base plate.

13. The device of claim 12 wherein the electronic circuitry comprises a processor system, a memory system, and a communication system.

14. The device of claim 13 wherein the electronic circuitry is configured to transmit data acquired in use of the device to an external computer system via the communication system.

15. The device of claim 14 wherein the data acquired is transmitted wirelessly.

16. The device of claim 1 wherein the plurality of beam sensing elements comprises three beam sensing elements and the mounting base comprises three beam sensing element connectors to attach each of the three of beam sensing elements to the mounting base to extend radially therefrom relative to an axis of the hub axle with a spacing between axes of the three beam sensing elements of approximately 120 degrees.

17. A method of measuring pushrim dynamics of a pushrim of a wheel of a wheelchair, comprising: replacing a hub of the wheel with a modular hub comprising a mounting base, the mounting base comprising beam sensing element connectors to attach each of a plurality of beam sensing elements to the mounting base in a predetermined spaced relation, an inner hub flange configured to be removably connected on an inner side of the mounting base, and an outer hub flange configured to be removably connected on an outer side of the mounting base, each of the inner hub flange and the outer hub flange being configured to be operatively connected to the wheel of the wheelchair, each of the mounting base, the inner hub flange, and the outer hub flange independently comprising a passage therethrough via which a hub axle can be passed, each of the plurality of beam sensing elements being configured to be placed in operating connection with the pushrim, each of the plurality of beam sensing elements having one or more sensors of a sensor system in operative connection therewith to measure bending of the beam sensing element.

18. The method of claim 17 wherein the inner hub flange comprises a plurality of connectors configured to connect spokes of the wheel thereto, and the outer hub flange comprises a plurality of connectors configured to connect spokes of the wheel thereto.

19. The method of claim 17 wherein the mounting base, the inner hub flange, and the outer hub flange are formed to be connected in a predetermined relative alignment.

20. The method of claim 17 further comprising determining speed of the wheel of the wheelchair and determining orientation of the wheel of the wheelchair via one or more sensors of the sensor system.

21.-27. (canceled)

28. A system, comprising
a wheelchair comprising a first wheel comprising a first pushrim and a second wheel comprising a second pushrim; and
a first device for measuring pushrim dynamics in operative connection with the first wheel and a second device for measuring pushrim dynamics in operative connection with the second wheel, each of the first device and the second device comprising:
a plurality of beam sensing elements configured to be placed in operative connection with the first pushrim and the second pushrim, independently,
a sensor system comprising one or more sensors in connection with each of the plurality of beam sensing elements to measure bending of the beam sensing element;
a modular hub comprising a mounting base, the mounting base comprising beam sensing element connectors to attach each of the plurality of beam sensing elements to the mounting base to extend radially from the mounting base in a predetermined spaced relation, an inner hub flange configured to be removably connected on an inner side of the mounting base, and an outer hub flange configured to be removably connected on an outer side of the mounting base, each of the inner hub flange and the outer hub flange being configured to be operatively connected to the first wheel and the second wheel of the wheelchair, independently, each of the mounting base, the inner hub flange, and the outer hub flange independently comprising a passage therethrough via which a hub axle can be passed.

29.-34. (canceled)
